(19) United States
(12) Patent Application Publication
(10) Pub. No.: US 2015/0116236 A1
(43) Pub. Date: Apr. 30, 2015

(54) ELECTRONIC DEVICE, STYLUS PEN, AND METHOD FOR PROVIDING TACTILE FEEDBACK IN ELECTRONIC DEVICE

(71) Applicant: Samsung Electronics Co., Ltd., Gyeonggi-do (KR)

(72) Inventor: Sun Ho KIM, Daegu (KR)

(73) Assignee: Samsung Electronics Co., Ltd.

(21) Appl. No.: 14/445,464

(22) Filed: Jul. 29, 2014

(30) Foreign Application Priority Data
Oct. 30, 2013 (KR) 10-2013-0129696

(51) Int. Cl. G06F 3/01; G06F 3/038; G06F 3/041; G06F 3/0354

(52) U.S. Cl. CPC G06F 3/016; G06F 3/03545; G06F 3/038; G06F 3/0416
USPC 345/173; 345/179

(57) ABSTRACT

An electronic device, stylus pen, and method for providing tactile feedback are provided. The electronic device includes a mode recognizing unit configured to recognize a change to a vibration mode, and a frequency processing unit configured to output a first frequency band signal through a touch screen upon entering the vibration mode and to output a second frequency band signal through the touch screen when a specific event occurs.

### PRIORITY

This application claims priority under 35 U.S.C. §119(a) to Korean Patent Application No. 10-2013-0129696, filed in the Korean Intellectual Property Office on Oct. 30, 2013, the entire disclosure of which is incorporated herein by reference.

### BACKGROUND

1. Field of the Invention

The present invention generally relates to an electronic device, stylus pen, and method for providing tactile feedback in the electronic device, and more particularly, to an electronic device, stylus pen, and method for providing tactile feedback that provides a feeling of writing to a user when using the stylus pen on the electronic device.

2. Description of the Related Art

With the recent development of digital technology, various electronic devices such as mobile communication terminals, Personal Digital Assistants (PDAs), electronic schedulers, smart phones, and tablet personal computers have been made which process communication and personal information while on the move. Since such electronic devices include touch pads and touch screens as output devices, users may easily enter data without separate input devices such as key pads and keyboards.

However, when users use their fingers to enter data on touch screens provided as such typical output devices, there is the limitation in that input accuracy decreases.

In addition, when an input operation is performed by using a stylus pen instead of a user's fingers, there are limitations in that input accuracy and the feeling of writing decrease due to the surface texture of touch screens.

### SUMMARY

The present invention has been made to address at least the above problems and disadvantages, and to provide at least the advantages described below. Accordingly, an aspect of the present invention provides an electronic device, stylus pen and method for providing tactile feedback that provide the feeling of writing to users when using stylus pens on electronic devices.

Another aspect of the present invention provides an electronic device, stylus pen and method for providing tactile feedback that enable users to check specific events operating on electronic devices, by touch through stylus pens that are used on electronic devices employing electromagnetic induction.

According to an aspect of the present invention, an electronic device for providing tactile feedback includes a mode recognizing unit configured to recognize a change to a vibration mode; and a frequency processing unit configured to output a first frequency band signal through a touch screen upon entering the vibration mode and to output a second frequency band signal through the touch screen when a specific event occurs.

According to another aspect of the present invention, a stylus pen for providing tactile feedback includes a variation checking unit configured to sense at least one of a variation in pressure applied to a pen tip and a variation in induced current induced on a core unit of the stylus pen; a vibration generating unit configured to control vibration generation in response to at least one of the induced-current variation and the pressure variation; and a linear motor configured to generate the vibration.

According to another aspect of the present invention, a method of providing tactile feedback in a stylus pen includes outputting a first frequency band signal; and outputting a second frequency band signal corresponding to a specific event when at least one specific event occurs.

According to a further aspect of the present invention, a method of providing tactile feedback includes checking whether external pressure is applied when an induced current is sensed on a core unit of a pen; and vibrating a linear motor in the pen if the external pressure is applied.

According to yet another aspect of the present invention, a method of providing tactile feedback includes sensing an induced current that is induced on a core unit of a pen; checking a variation in the induced current; and vibrating a linear motor in the pend according to the variation.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a stylus pen operating system for proving tactile feedback according to an embodiment of the present invention;

FIG. 2 is a block diagram illustrating main components of an electronic device for proving tactile feedback according to an embodiment of the present invention;

FIG. 3 is a sectional view of a stylus pen for proving tactile feedback according to an embodiment of the present invention;

FIG. 4 is a block diagram illustrating main components of a Micro Control Unit (MCU) in FIG. 3;

FIG. 5 is a flowchart of a method of providing tactile feedback to a stylus pen in an electronic device according to an embodiment of the present invention;

FIG. 6 is a flowchart of a method of providing tactile feedback according to a pressure variation of a stylus pen according to an embodiment of the present invention;

FIG. 7 is a flowchart of a method of providing tactile feedback according to a signal variation of a frequency band of an electronic device according to an embodiment of the present invention;

FIGS. 8A and 8B illustrate screen related to an interface providing notice of entrance into a vibration mode according to an embodiment of the present invention;

FIG. 9 illustrates a screen related to an interface providing tactile feedback when a specific app is executed according to an embodiment of the present invention; and

FIGS. 10A to 10C illustrate screens related to an interface providing tactile feedback when a data storing operation is completed according to an embodiment of the present invention.

### DETAILED DESCRIPTION OF EMBODIMENTS OF THE PRESENT INVENTION

Various embodiments of the present invention are described below in more detail with reference to the accompanying drawings. However, when describing embodiments, technical matters that are well-known in the technical field to which the present invention pertains and that have no direct relevance to the present invention are not described, in order to more clearly describe the present invention, and to avoid obscuring the subject matter of the present invention.

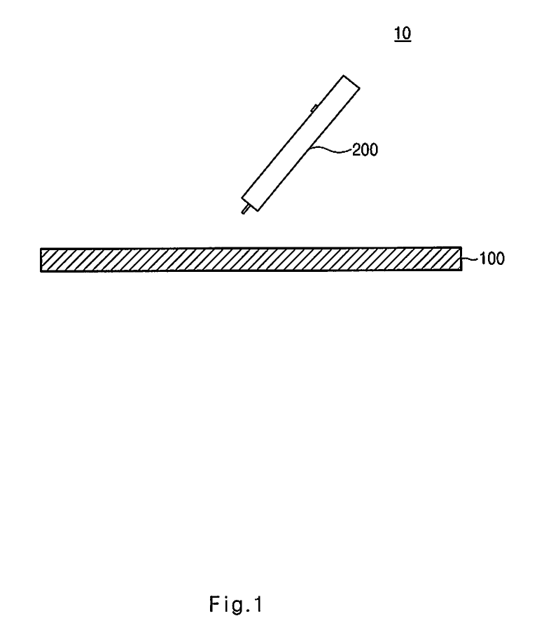

FIG. 1 illustrates a stylus pen operating system for proving tactile feedback according to an embodiment of the present invention.

Referring to FIG. 1, a stylus pen operating system 10 for providing tactile feedback to a user includes an electronic device 100 and a stylus pen 200, and various embodiments using them are as follows.

According to an embodiment of the present invention, if external pressure is applied to the stylus pen 200 without relevance to the electronic device 100, the stylus pen 200 checks a variation in pressure. The stylus pen 200 may generate a vibration according to the checked pressure and provide tactile feedback to a user.

According to another embodiment of the present invention, if the stylus pen 200 is moved to within a certain distance from the electronic device 100 that outputs a certain frequency or the stylus pen 200 is in touch with the electronic device 100, it is possible to generate a vibration corresponding to an induced current of the stylus pen 200 and provide tactile feedback to the user.

According to another embodiment of the present invention, if external pressure is applied to the stylus pen 200 while the stylus pen 200 is moved to within a certain distance from the electronic device 100 that outputs a certain frequency or the stylus pen 200 is in touch with the electronic device 100, the stylus pen 200 may generate a vibration according to a variation in pressure and provide tactile feedback to the user.

According to another embodiment of the present invention, if the induced current of the stylus pen 200 varies in response to a variation in frequency of the electronic device 100 when a specific event occurs, the stylus pen 200 may generate a vibration according to the varied induced current and provide tactile feedback to the user.

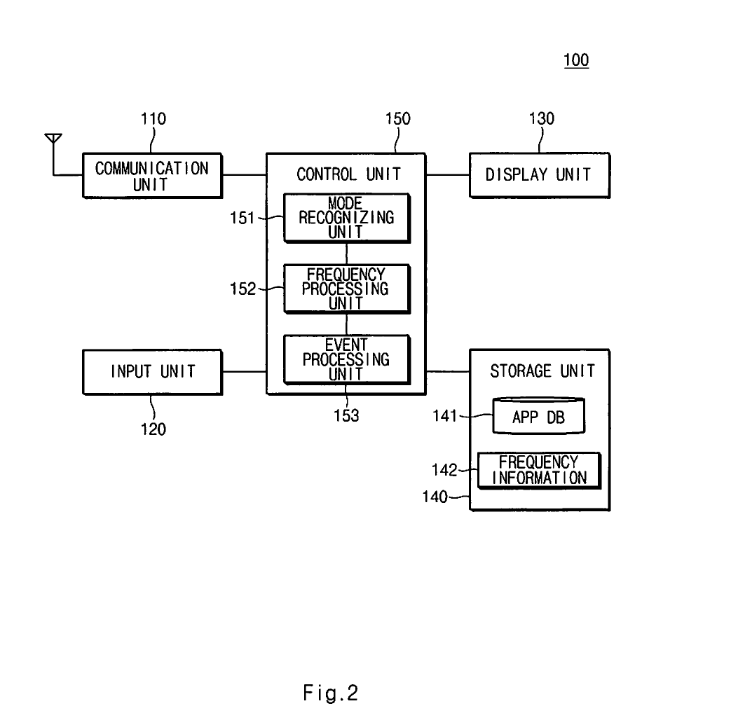

FIG. 2 is a block diagram illustrating the main components of the electronic device for proving tactile feedback according to an embodiment of the present invention.

Referring to FIGS. 1 and 2, the electronic device 100 for providing tactile feedback to the user may include a communication unit 110, an input unit 120, a display unit 130, a storage unit 140, and a control unit 150.

The communication unit 110 forms a communication channel for supporting a chatting function. In this process, the user may use the stylus pen 200 to perform a text input operation or an image input operation. If an event to perform a specific text or image transmission operation through the communication unit 110 occurs, the electronic device 100 may perform a frequency variation.

The input module 120 generates an input signal for setting a vibration mode of the stylus pen 200. For example, the input module 120 may allocate a specific key button as a hot key for setting the vibration mode. When setting the vibration mode, the electronic device 100 may support a variation in induced current of the stylus pen 200 through a frequency variation.

The display unit 130 is formed as a touch screen that performs an input function by using an input member including the stylus pen 200, and delivers an input signal to the control unit 150. The touch screen may generate an event due to the contact or approach of the stylus pen 200. The touch screen may be formed as one of various panels such as a capacitive panel or an electromagnetic induction panel, according to the characteristics of the stylus pen 200. The display unit 130 displays a user interface for the operation of the electronic device 100 according to the control of the control unit 150. Also, the display unit 130 displays an execution screen for an application executed according to the control of the control unit 150.

The storage unit 140 stores, in an app DB 141, programs or applications for operating the electronic device 100. Also, the storage unit 140 stores, in frequency information 142, a table such as Table 1 below in order to output signals of different frequency bands according to the mode. In this case, the type of event and an event-dependent frequency band that are set in Table 1 are arbitrarily provided to describe the present invention, and thus it should be noted that the present invention is not limited thereto.

TABLE 1

| | Ban | Event | Vibratio |
|---|---|---|---|
| First | 100 | Vibration mode | Weak |
| Second | 200 | MP3 app execution | Medium |
| Third | 300 | Data storage completion check | Strong |

The control unit 150 enters the vibration mode of the stylus pen so that the stylus pen 200 may vibrate to provide tactile feedback to a user. The control unit 150 outputs a first frequency band signal to a touch screen of the display unit 130 when entering the vibration mode, and outputs a second frequency band signal or a third frequency band signal to the touch screen of the display unit 130 when at least one specific event occurs. To that end, the control unit 150 may include a mode recognizing unit 151, a frequency processing unit 152, and an event processing unit 153. According to an embodiment of the present invention, if the stylus pen 200 is formed to be removable from a part of the electronic device 100 and is detached from the electronic device 100, the mode recognizing unit 151 may recognize a request for a change to a vibration mode and enter the vibration mode.

According to another embodiment of the present invention, if an input signal for a mode change is generated through the display unit 130 having an input function or through the input unit 120, the mode recognizing unit 151 may recognize a request for a change to a vibration mode and enter the vibration mode.

According to another embodiment of the present invention, if an input signal for a mode change is received from the stylus pen 200, the mode recognizing unit 151 recognizes a request for a change to a vibration mode and enters the vibration mode. In order to receive an input signal from the stylus pen 200, the electronic device 100 may include a receiving unit (not shown) and the stylus pen 200 may include a transmitting unit (not shown). The mode recognizing unit 151 may check an input signal received through the receiving unit and enter a vibration mode. Also, the mode recognizing unit 151 may receive an induced current generated by the pressing of a switch formed by the stylus pen 200 to enter the vibration mode.

If the mode recognizing unit 151 enters the vibration mode, the frequency processing unit 152 outputs, to a touch screen of the display unit 130, a first frequency band signal set in the vibration mode as illustrated in Table 1.

If a signal to execute an MP3 app from among at least one app displayed on the display unit 130 is received through the display unit 130, the event processing unit 153 notifies the frequency processing unit 152 that the signal to execute the MP3 app is input. If the MP3 app preset as a specific event is executed, the frequency processing unit 152 changes the first frequency band signal to a second frequency band signal as illustrated in Table 1 and outputs, to the touch screen of the display unit 130, the signal generated due to the change.

Also, when storing various data such as multimedia data, phone number data, and text message data is completed, the event processing unit 153 displays, on the display unit 130, a pop-up window providing notice of data storage completion. The event processing unit 153 provides to the frequency processing unit 152 a signal providing notice that the pop-up window is displayed. If the pop-up window providing notice that the data storage completion preset as a specific event is displayed, the frequency processing unit 152 changes the first frequency band signal to a third frequency band signal as illustrated in Table 1 and outputs, to the touch screen of the display unit 130, the signal generated due to the change.

If an MP3 app execution or a pop-up window display that is preset as a specific event is completed, the frequency processing unit 152 re-outputs the first frequency band signal to the touch screen of the display unit 130.

According to an embodiment of the present invention, the stylus pen 200 may change the vibration type according to a specific event being executed on the electronic device 100 and provide the operation state of the electronic device 100 to a user in a tactile manner. To this end, since the stylus pen 200 changes the vibration type based on a current induced from signals of frequency bands output from the electronic device 100, the frequency processing unit 152 outputs signals of various frequency bands to the touch screen of the display unit 130.

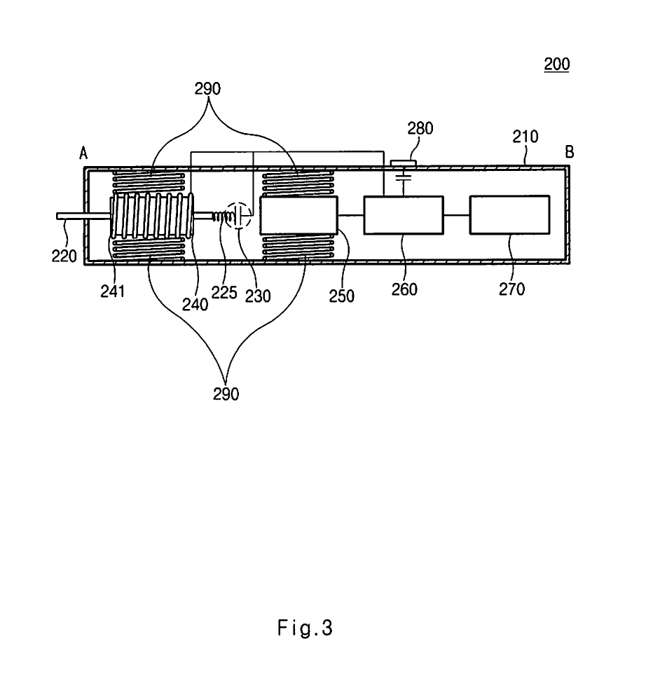

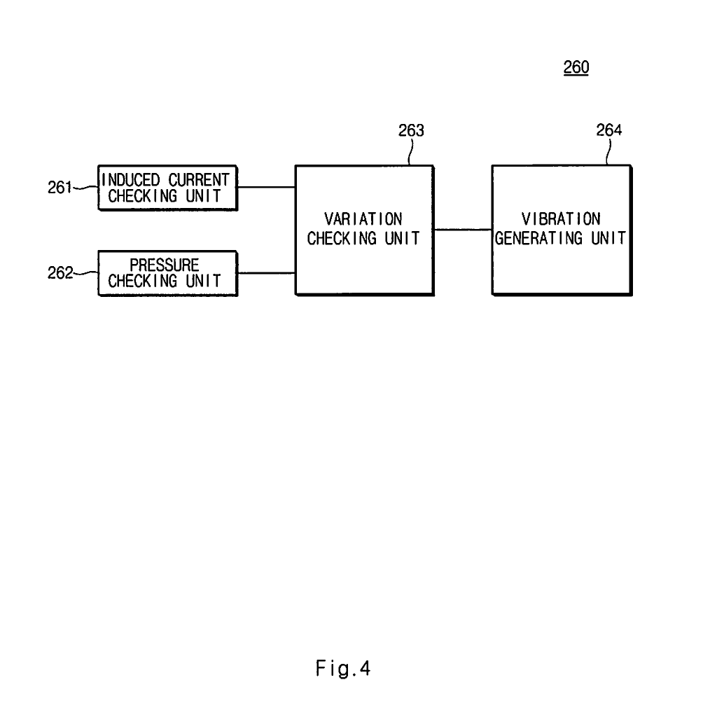

FIG. 3 is a sectional view of a stylus pen for proving tactile feedback according to an embodiment of the present invention, and FIG. 4 is a block diagram illustrating main components of a Micro Control Unit (MCU) in FIG. 3.

Referring to FIGS. 2 to 4, the stylus pen 200 according to an embodiment of the present invention includes a housing 210, a pen tip 220, an elastic member 225, a piezoelectric element 230, a core unit 240, a motor unit 250, an MCU 260, a power supply unit 270, a switch 280, and a buffer member 290.

The housing 210 is provided to cover a part of the pen tip 220, the elastic member 225, the piezoelectric element 230, the core unit 240, the motor unit 250, the MCU 260, the power supply unit 270, and the buffer member 290. The housing 210 has a certain length and a certain sectional area so that it is easy for a user to hold the stylus pen 200 with his/her hand. In order to enhance a user's grip feel, the housing 210 may have a recessed portion (not shown) where the user's fingers touch the housing 210. A hole is formed at one end A of the housing 210 so that the pen tip may protrude therethrough.

At least a part of the pen tip 220 is formed to protrude from one end A of the housing 210 so that it is easy for a user to input something on the electronic device 100 by using the stylus pen 200. In particular, the pen tip 220 is in touch with the elastic member 225 through the core unit 240.

The elastic member 225 is arranged an one end of the pen tip 220 inside housing 210. In particular, the elastic member 225 is arranged on the other end of the pen tip 220 that protrudes to the outside of the housing 210. When pressure is applied to the pen tip 220 that is in contact with the electronic device 100, the pen tip 220 thus moves toward the other end B of the housing 210, and the elastic member 225 then provides elasticity to the moved pen tip 220. If the pressure applied to the pen tip 220 is removed, the elastic member 225 returns the pen tip 220 to its original location.

The piezoelectric element 230 is coupled to the elastic member 225 and senses the intensity of pressure generated when the pen tip 220 moves toward the other end B of the housing 210 by the pressure applied to the pen tip 220. The piezoelectric element 230 provides the sensed intensity of pressure to the MCU 260. In this case, the intensity of pressure is sensed by at least one of an inductance variation and a capacitance variation.

The core unit 240 is formed by winding coils 241 on the outer circumferential surface of a core formed of an electromagnet including ferrite. If the stylus pen 200 is within a certain distance from the electronic device 100, the core unit 240 forms an induced current from signals of frequency bands output from the electronic device 100, and provides the induced current to the MCU 260.

The motor unit 250 may include a linear motor to generate vibration based on the vibration type set in the MCU 260.

The MCU 260 senses the induced current from signals of specific frequency bands output from the electronic device 100, and controls the motor unit 250 so that after checking a variation in pressure generated externally, the linear motor of motor unit 250 is vibrated. The MCU 260 may set the vibration type to vibrate the vibration motor. The types of vibration may be differentiated by varying at least one of a vibration level that sets the intensity of vibration, a vibration interval, and a vibration time.

The power supply unit 270 may be a battery that may be inserted into the housing 210, and may be rechargeable.

The switch 280 is located on the outside of the housing 210 and transmits, to the electronic device 100, control signals for various functions such as a function to delete numeric, figure, and text data that are input to the electronic device 100 by using the stylus pen 200. Also, the switch 280 may generate an input signal to change the mode of the electronic device 100 to a vibration mode and transmit the generated input signal to the electronic device 100.

The buffer member 290 is formed between the core unit 240 and the housing 210 and fixes the core unit 240 to the inside of the housing 210. Also, the buffer member 290 is formed between the motor unit 250 and the housing 210 and minimizes noise and wear caused when the motor unit 250 impinges with the housing 210 due to vibration.

According to an embodiment of the present invention, the stylus pen 200 checks a variation in pressure generated externally and generates a vibration accordingly. To this end, the MCU 260 may include a pressure checking unit 262, a variation checking unit 263, and a vibration generating unit 264, as shown in FIG. 4.

The pressure checking unit 262 checks, in real time, the intensity of pressure generated by the pen tip 220 sensed by the piezoelectric element 230. The pressure checking unit 262 provides the checked intensity of pressure to the variation checking unit 263.

The variation checking unit 263 checks a pressure variation from the intensity of pressure provided from the pressure checking unit 262. When a user performs an input operation on the electronic device 100 by using the stylus pen 200, the variation checking unit 263 checks a variation in pressure applied to the stylus pen 200 and recognizes a writing pressure.

The vibration generating unit 264 sets the vibration type for the linear motor based on the writing pressure recognized by the variation checking unit 263 and controls the vibration generation of the linear motor. In addition, if the writing pressure is not recognized by the variation checking unit 263, namely, the pressure applied to the pen tip 220 is removed, the vibration generating unit 264 stops generating vibration.

Thus, according to an embodiment of the present invention, since the stylus pen 200 may operate alone without an operation associated with the electronic device 100, a user may receive tactile feedback on his/her input operation even if the input operation is performed on other devices instead of the electronic device 100. In particular, since the vibration type varies depending on the magnitude of pressure applied to the pen tip 220 of the stylus pen 200 by the user, it is possible to provide, to the user, the feeling of writing (as if the user was using a pen to write on paper) in response to an input operation. In this case, since the stylus pen 200 has no need to use induced current from signals of frequency bands of the electronic device 100, the core unit 240 may be omitted in the housing 210.

According to another embodiment of the present invention, if the stylus pen 200 is in contact with the electronic device 100 outputting a specific frequency, the stylus pen 200 generates vibration corresponding to induced current according to the specific frequency. To this end, the MCU 260 may include an induced-current checking unit 261, a variation checking unit 263, and a vibration generating unit 264, as shown in FIG. 4.

Since the induced-current checking unit 261 is located within a certain distance from the electronic device 100, it is possible to check current induced on the core unit 240. The induced-current checking unit 261 provides the checked induced current to the variation checking unit 263.

The variation checking unit 263 checks a variation in the induced current provided from the induced-current checking unit 261 and provides the checked variation to the vibration generating unit 264. In this case, the variation in the induced current may depend on the distance between the core unit 240 and the electronic device 100.

The vibration generating unit 264 sets the vibration type of the linear motor of the motor unit 250based on the variation in the induced current provided from the variation checking unit 263 and controls the vibration generation of the linear motor.

Thus, according to another embodiment of the present invention, if the stylus pen 200 is located within a specific distance from the electronic device 100, it generates vibration even when pressure is not applied to the pen tip 220 of the stylus pen 200, and thus it is possible to provide a user with tactile feedback on whether the stylus pen 200 is located within a range in which the stylus pen 200 may perform an input operation on the electronic device 100. In particular, since the vibration type varies depending on the distance between the stylus pen 200 and the electronic device 100, it is possible to provide a user with tactile feedback when the stylus pen 200 is in contact with the electronic device 100, and thus it is possible to perform an input operation. In this case, since the stylus pen 200 has no need to recognize writing pressure, the elastic unit 225 and the piezoelectric element 230 may be omitted. Also, in this case, the core unit 240 has no need for a design in which the pen tip 220 passes through the core unit 240, and the location of the core unit 240 may be freely designed and changed in the housing 210.

According to another embodiment of the present invention, if external pressure is applied to the stylus pen 200 while current induced from frequencies output from the electronic device 100 are generated, the stylus pen 200 checks a variation in pressure and generates vibration accordingly. To this end, the MCU 260 may include an induced-current checking unit 261, a pressure checking unit 262, a variation checking unit 263, and a vibration generating unit 264.

The induced-current checking unit 261 checks current induced on the core unit 240 when the stylus pen 200 is positioned within a certain distance from the electronic device 100. The induced-current checking unit 261 provides the induced current to the variation checking unit 263.

The pressure checking unit 262 checks, in real time, the intensity of pressure generated by the pen tip 220 sensed by the piezoelectric element 230 and provides the checked intensity of pressure to the variation checking unit 263.

The variation checking unit 263 checks a variation in the induced current provided from the induced-current checking unit 261 and checks a variation in pressure from the intensity of pressure provided by the pressure checking unit 262. In this case, the variation in the induced current may depend on the distance between the core unit 240 and the electronic device 100. In addition, the variation checking unit 263 checks the checked variation in the induced current to approximate the distance between the core unit 240 and the electronic device 100 and checks the variation in pressure to check writing pressure.

The vibration generating unit 264 sets the vibration type of the linear motor of the motor unit 250 based on the variations in the induced current and the pressure that are provided from the variation checking unit 263, and controls the vibration generation of the linear motor.

Thus, according to another embodiment of the present invention, if the stylus pen 200 is located within a specific distance from the electronic device 100 and pressure is applied to the pen tip 220 of the stylus pen 200, it is possible to provide the feeling of writing to a user.

According to another embodiment of the present invention, a specific event occurs on the electronic device 100 and the stylus pen 200 generates vibration in response to a variation in induced-current according to a frequency varying depending on the event that occurs on the electronic device 100. To this end, the MCU 260 may include an induced-current checking unit 261, a variation checking unit 263, and a vibration generating unit 264.

The induced-current checking unit 261 checks current induced on the core unit 240 when the stylus pen 200 is positioned within a certain distance from the electronic device 100, and provides the checked induced currents to the variation checking unit 263. In this case, the core unit 240 generates current induced from signals of different frequency bands according to an event that occurs on the electronic device 100. More particularly, as a specific event as illustrated in Table 1 occurs on the electronic device 100, a frequency band signal output through the display unit 130 varies from a first frequency band signal to a second or third frequency band signal. Since the varied frequency band signal induces current on the core unit 240, there is a variation in the induced current that is checked by the induced-current checking unit 261.

The variation checking unit 263 checks a variation in the induced current provided from the induced-current checking unit 261 and provides the checked variation to the vibration generating unit 264. In this case, the variation in the induced current may depend on a specific event that occurs on the electronic device 100.

The vibration generating unit 264 sets the vibration type of the linear motor based on the variation in the induced current provided from the variation checking unit 263 and controls the vibration generation of the linear motor. In this case, the vibration type may be preset through a setting between the vibration generating unit 264 and the electronic device 100.

Thus, according to another embodiment of the present invention, by providing as tactile feedback to a user an operation according to an event that occurs on the electronic device 100, the user may recognize a change in an operation that occurs on the electronic device 100 through the stylus pen 200. Also, in another embodiment of the present invention, it is possible to generate vibration defined by the electronic device 100 when an event occurs and it is possible to generate vibration on the linear motor in response to a variation in an induced current which varies depending on the distance between the electronic device 100 and the stylus pen 200 and in response to a variation in pressure applied to the pen tip 220 of the stylus pen 200.

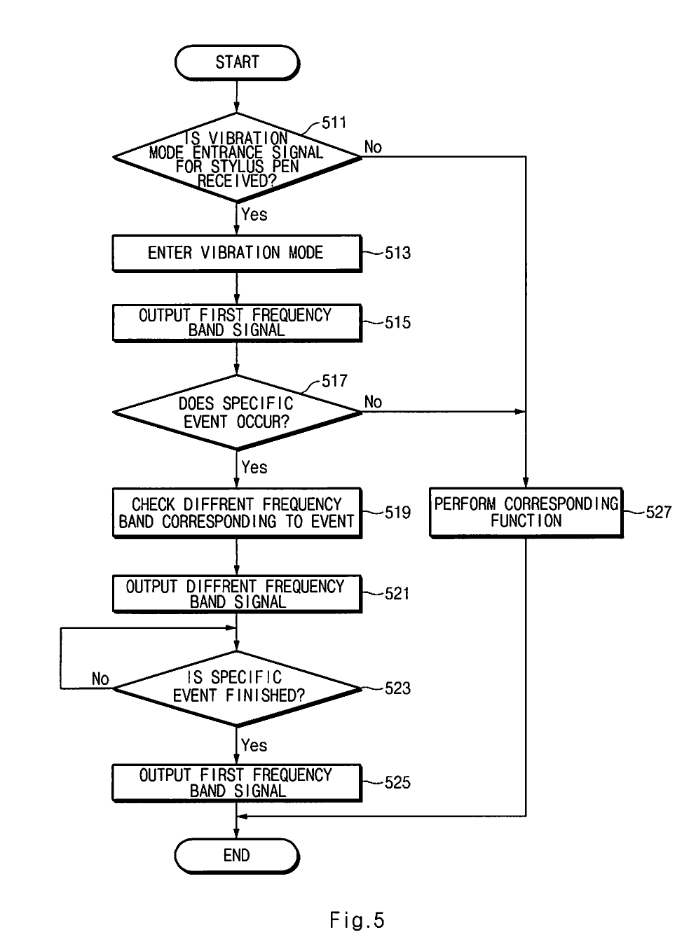

FIG. 5 is a flowchart of a method of providing tactile feedback to a stylus pen in an electronic device according to an embodiment of the present invention.

Referring to FIGS. 1 to 5, in step 511, the control unit 150 checks whether the vibration mode of the stylus pen 200 is set so that the stylus pen 200 may vibrate to provide tactile feedback to a user. For example, the control unit 150 may check whether the vibration mode is set by default or a signal to enter the vibration mode is generated. If as a result of checking in step 511, the vibration mode is set or the signal to enter the vibration mode is received, the control unit 150 proceeds to step 513, and if the vibration mode is not set or the signal to enter the vibration mode is not received, the control unit 150 proceeds to step 527 and performs a corresponding function in response to an external input. In this case, the signal to enter the vibration mode may be any one of a signal providing notice that the stylus pen 200, formed to be removable from the electronic device 100, is detached from the electronic device 100, an external mode change input signal that is generated through the display unit 130 having an input function or the input unit 120, and an input signal for a mode change received from the stylus pen 200.

In step 513, the control unit 150 enters the vibration mode and outputs on a touch screen of the display unit 130, a first frequency band signal corresponding to the vibration mode as illustrated in Table 1, in step 515.

Subsequently, in step 517, if a specific event occurs, the control unit 150 proceeds to step 519 and checks a different frequency band signal corresponding to the specific event, such as a second or third frequency band signal. If a specific event has not occurred in step 517, the control unit 150 proceeds to step 527 and performs a corresponding function in response to an external input.

In step 521, the control unit 150 outputs the checked frequency band signal to the touch screen of the display unit 130 and in step 523, the control unit 150 checks whether the specific event occurring in step 517 has ended.

In step 523, if the specific event has ended, the control unit 150 proceeds to step 525, and if the specific event has not ended, the control unit 150 waits for the end of the specific event.

Subsequently, in step 525, the control unit 150 varies and outputs a frequency from a different frequency band signal being output on the touch screen of the display unit 130 in step 521 to the first frequency band signal corresponding to the vibration mode.

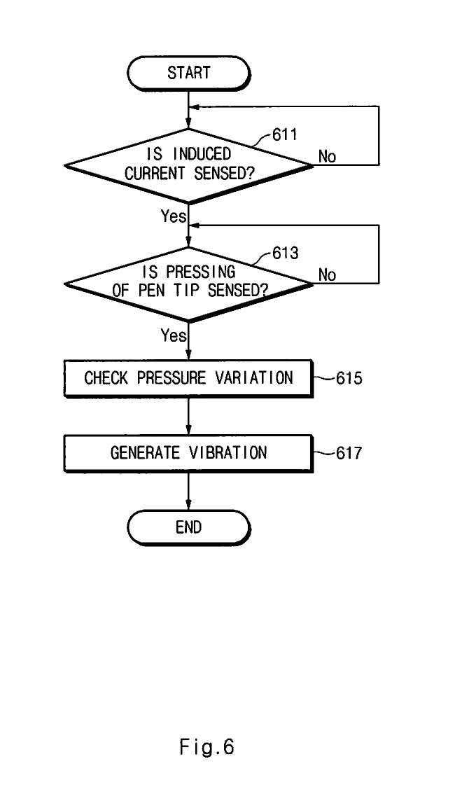

FIG. 6 is a flowchart of a method of providing tactile feedback according to a pressure variation of a stylus pen according to an embodiment of the present invention.

Referring to FIGS. 1 to 6, in step 611, the MCU 260 checks whether an induced current, which is induced from a frequency band signal output from the electronic device 100, is sensed on the core unit 240. If the induced current is sensed on the core unit 240 in step 611, the MCU 260 proceeds to step 613. If the induced current is not sensed, the MCU 260 waits until the induced current is sensed.

In step 613, the MCU 260 senses the pressing of the pen tip 220 from the piezoelectric element 230. If the pressing of the pen tip 220 is sensed in step 613, the MCU 260 proceeds to step 615, and if the pressing of the pen tip 220 is not sensed, the MCU 260 waits until the pressing of the pen tip 220 is sensed. In this case, if the pen tip 220 is pressed by external pressure, a pressure variation occurs on the piezoelectric element 230 which provides the pressure variation to the MCU 260.

Subsequently, in step 615, the MCU 260 checks a pressure variation depending on the pressing of the pen tip 220 provided in step 613, and in step 617, the MCU 260 controls the linear motor included in the motor unit 250 to generate vibration according to the pressure variation.

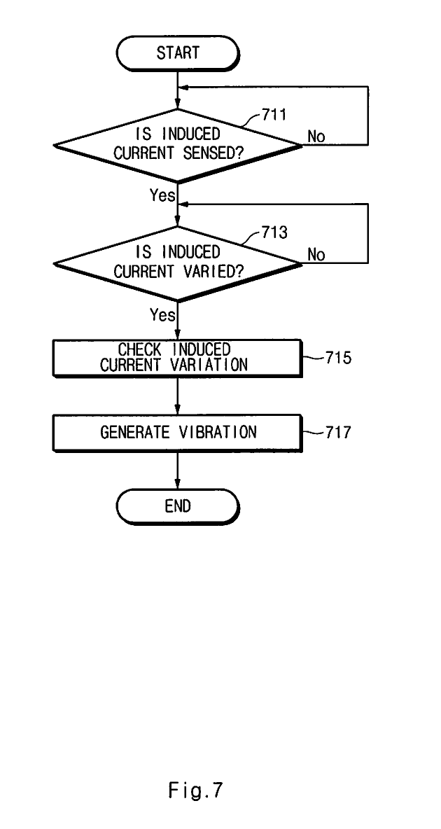

FIG. 7 is a flowchart of a method of providing tactile feedback according to a signal variation of a frequency band of an electronic device according to an embodiment of the present invention.

Referring to FIGS. 1 to 7, in step 711, the MCU 260 checks whether an induced current, which is induced from a frequency band signal output from the electronic device 100, is sensed on the core unit 240. If the induced current is sensed on the core unit 240 in step 711, the MCU 260 proceeds to step 713, and if the induced current is not sensed, the MCU 260 waits until the induced current is sensed.

In step 713, the MCU 260 checks whether there is a variation in the induced current. If there is a variation in the induced current in step 713, the MCU 260 proceeds to step 715, and if there is no variation in the induced current, the MCU 260 waits until a variation in the induced current is sensed. In this case, a variation in the induced current may occur depending on the distance between the stylus pen 200 and the electronic device 100, or due to a variation in a frequency band signal output from the display unit 130 when a specific event occurs on the electronic device 100.

Subsequently, in step 715, the MCU 260 checks an induced current variation and in step 717, the MCU 260 controls the linear motor included in the motor unit 250 according to the checked induced current variation to generate vibration according to the induced current variation.

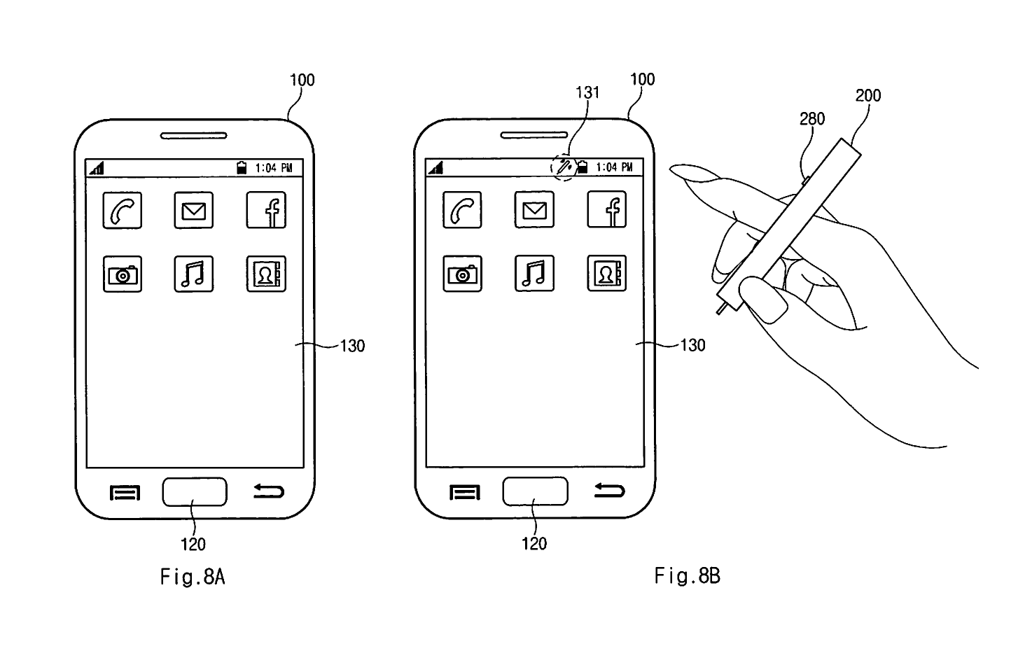

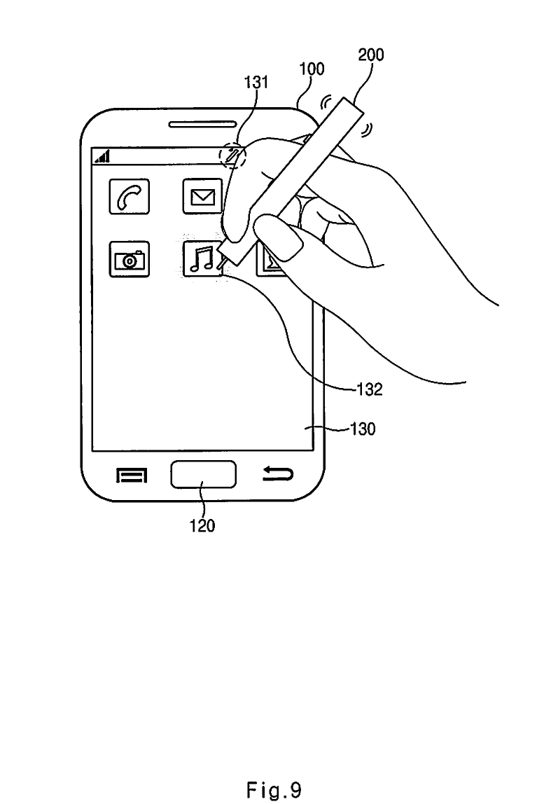

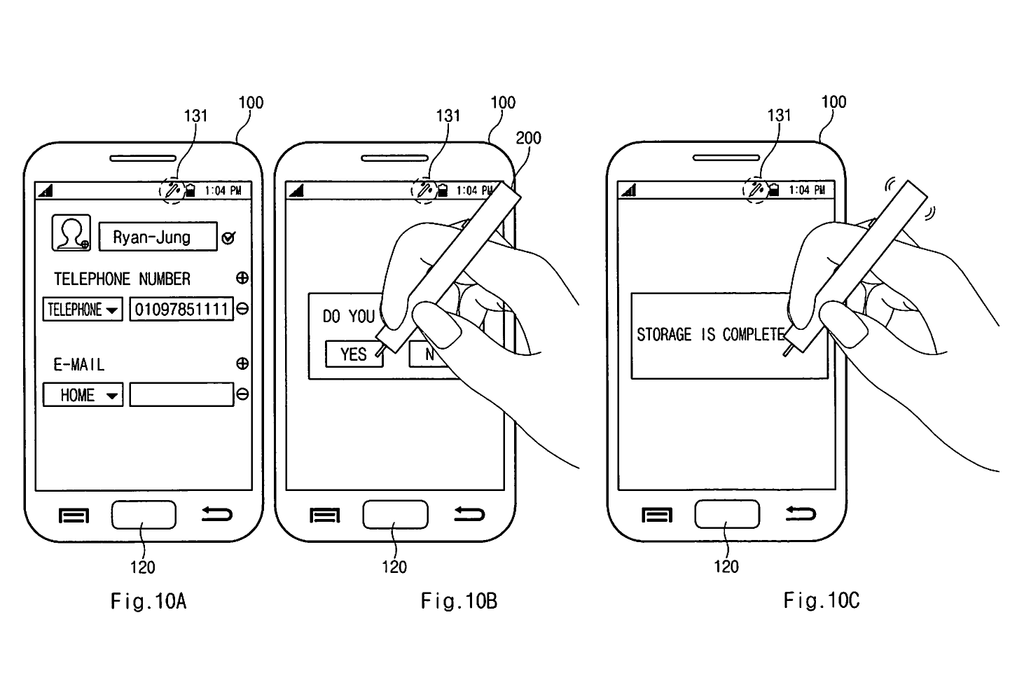

FIGS. 8A and 8B illustrate screens related to an interface providing notice of entrance into a vibration mode according to an embodiment of the present invention. FIG. 9 illustrates a screen related to an interface providing tactile feedback when a specific app is executed according to an embodiment of the present invention. FIG. 10A to 10C illustrate screens related to an interface providing tactile feedback when a data storing operation is completed according to an embodiment of the present invention.

Referring to FIGS. 1, 2, 8A and 8B, FIG. 8A shows a screen interface displayed on the display unit 130 of a general electronic device 100. If a user detaches the stylus pen 200 from the electronic device 100, operates the switch 280 on the stylus pen 200 or selects a specific menu from the display unit 130, an icon 131 providing notice of entrance into a vibration mode in which the stylus pen 200 is vibrated is displayed on the status bar of the display unit 130 as illustrated in FIG. 8B.

In addition, the electronic device 100 outputs, to a touch screen of the display unit 130, a first frequency band signal corresponding to a vibration mode event in Table 1.

Referring to FIGS. 1, 2 and 9, if a signal to execute an MP3 app is input from the stylus pen 200 as illustrated in FIG. 9 while a first frequency band signal is output, the electronic device 100 varies the frequency to a second frequency band signal corresponding to an event to execute the MP3 app in Table 1, and outputs it to the touch screen of the display unit 130. Thus, since an induced current variation from the current induced from the first frequency band signal to a current induced from the second frequency band signal occurs, the stylus pen 200 generates vibration according to the variation that occurs. In addition, since the electronic device 100 varies the second frequency band signal back to the first frequency band signal after executing an MP3 app, an induced current variation occurs again on the stylus pen 200. Thus, the stylus pen 200 again generates vibration according to the induced current variation that occurs.

Referring to FIGS. 1, 2 and 10A to 10C, if a signal to input a phone number as illustrated in FIGS. 10A to 10C is input while a first frequency band signal is output and a pop-up window to provide notice that data storage is completed is displayed as illustrated in FIG. 10C, the electronic device 100 varies the frequency to a third frequency band signal corresponding to a pop-up operation to check data storage completion in Table 1, and outputs it to the touch screen of the display unit 130. Thus, since an induced current variation from the current induced from the first frequency band signal to a current induced from the third frequency band signal occurs, the stylus pen 200 generates vibration according to the variation that occurs. In addition, since the electronic device 100 varies the third frequency band signal back to the first frequency band signal if the pop-up window is removed from the display unit 130 after a certain time passes, an induced current variation occurs again on the stylus pen 200. Thus, the stylus pen 200 generates vibration again according to the induced current variation that occurs.

As described above, the present invention has an effect whereby it is possible to provide the feeling of writing to a user by including the linear motor in the stylus pen for providing tactile feedback and vibrating the linear motor according to the user's writing pressure.

Also, the present invention varies a frequency output from the electronic device if an event occurs, allocates a command to the varied frequency and then vibrates the linear motor according to the command allocated to the varied frequency. Thus, the present invention has an effect whereby a user may check, through vibration, a variation in an operation according to an event occurring on the electronic device.

An electronic device, stylus pen, and method for providing tactile feedback according to the present invention have been described. Although the specification and the drawings disclose embodiments of the present invention and specific terms are used, these are merely used to easily describe the technical matters of the present invention and as general meanings for helping in the understanding of the present invention, and are not intended to limit the scope of the present invention. It is obvious to a person skill in the art to which the present invention pertains that other variations based on the technical spirit of the present invention may be made in addition to the embodiments described above.

What is claimed is:

1. An electronic device for providing tactile feedback, the electronic device comprising:
a mode recognizing unit configured to recognize a change to a vibration mode; and
a frequency processing unit configured to output a first frequency band signal through a touch screen upon entering the vibration mode and to output a second frequency band signal through the touch screen when a specific event occurs.

2. The electronic device according to claim 1, wherein the specific event includes at least one of a signal generated based on whether a stylus pen is removed from the electronic device, an input signal generated from the stylus pen, and a mode change input signal that is generated externally.

3. The electronic device according to claim 1, further comprising a storage unit that stores at least one piece of frequency band information corresponding to the specific event.

4. The electronic device according to claim 3, wherein the stylus pen generates vibration based on an induced current that is induced from the frequency band signal.

5. A stylus pen for providing tactile feedback, the stylus pen comprising:
a variation checking unit configured to sense at least one of a variation in pressure applied to a pen tip and a variation in induced current induced on a core unit of the stylus pen;
a vibration generating unit configured to control vibration generation in response to at least one of the induced current variation and the pressure variation; and
a linear motor configured to generate the vibration.

6. The stylus pen according to claim 5, wherein the variation checking unit checks a variation in the induced current caused by a variation in a frequency band signal for a specific event that occurs on an electronic device that is in contact with the pen tip.

7. The stylus pen according to claim 6, wherein the core unit is formed by winding coils on an outer circumferential surface of an electromagnetic core including a ferrite core.

8. A method of providing tactile feedback in a stylus pen, the method comprising:
outputting a first frequency band signal; and
outputting a second frequency band signal corresponding to a specific event when at least one specific event occurs.

9. The method according to claim 8, wherein the specific event includes at least one of a signal generated based on whether the stylus pen is removed from an electronic device, an input signal generated from the stylus pen, and a mode change input signal that is generated externally.

10. A method of providing tactile feedback, the method comprising:
checking whether external pressure is applied when an induced current is sensed on a core unit of a pen; and
vibrating a linear motor in the pen if the external pressure is applied.

11. The method according to claim 10, wherein checking whether external pressure is applied includes checking whether a pen tip located on one end of the stylus pen is pressed.

12. A method of providing tactile feedback, the method comprising:
sensing an induced current that is induced on a core unit of a pen;
checking a variation in the induced current; and
vibrating a linear motor in the pen according to the variation.

13. The method according to claim 12, wherein checking a variation in the induced current includes checking a variation in the induced current caused by a variation in a frequency band signal for a specific event occurring on an electronic device that is in contact with a pen tip of the stylus pen.
